(19) United States
(12) Patent Application Publication
(10) Pub. No.: US 2023/0196825 A1
(43) Pub. Date: Jun. 22, 2023

(54) FACE KEY POINT DETECTION METHOD AND APPARATUS, AND ELECTRONIC DEVICE

(71) Applicant: BEIJING BAIDU NETCOM SCIENCE TECHNOLOGY CO., LTD., Beijing (CN)

(72) Inventors: Hanqi Guo, Beijing (CN); Zhibin Hong, Beijing (CN); Yang Kang, Beijing (CN)

(73) Assignee: BEIJING BAIDU NETCOM SCIENCE TECHNOLOGY CO., LTD., Beijing (CN)

(21) Appl. No.: 17/925,380

(22) PCT Filed: Sep. 23, 2020
(86) PCT No.: PCT/CN2020/116994

§ 371 Date: Nov. 15, 2022

(30) Foreign Application Priority Data
May 15, 2020 (CN) 202010415188.1

(51) Int. Cl. G06V 40/16; G06V 10/44

(52) U.S. Cl. CPC G06V 40/161; G06V 10/449; G06V 40/171; G06V 40/172

(57) ABSTRACT

A method for detecting facial key points includes obtaining a face image to be detected, and extracting key point detection information of the face image to be detected; obtaining key point template information of the template face image; determining a facial key point mapping relationship between the face image to be detected and the template face image in combination with the key point detection information and the key point template information; and filtering the key point detection information according to the facial key point mapping relationship and the key point template information to generate target key point information of the face image to be detected, wherein target facial key points in the target key point information are facial key points of an un-block area in the face image to be detected.

### CROSS REFERENCE TO RELATED APPLICATIONS

This application is a U.S. National Phase Application of International Application No. PCT/CN2020/116994, filed on Sep. 23, 2020 which, claims priority and benefits to Chinese Application No. 202010415188.1, filed on May 15, 2020, the entire contents of which are incorporated herein by reference.

### TECHNICAL FIELD

The disclosure relates to a field of image processing technologies and specifically to fields of deep learning and computer vision technologies, and in particular to a method and a device for detecting key points of a face, an electronic device and a storage medium.

### BACKGROUND

With the development of deep learning technology and the rapid improvement of computer computing capabilities, the fields of artificial intelligence, computer vision and image processing have developed rapidly. The face recognition technology, as a classic subject in the field of computer vision, has great researchability and application value. The face recognition technology can detect key points of each face in the face image, such as the key points corresponding to the eyes and the mouth, and then perform face recognition according to the detected key points of the face.

### SUMMARY

A method and device for detecting key points of a face, an electronic equipment and a storage medium are provided.

According to a first aspect, a method for detecting facial key points is provided. The method includes: obtaining a face image to be detected; extracting key point detection information of the face image to be detected; obtaining key point template information of a template face image; determining a facial key point mapping relationship between the face image to be detected and the template face image by combining the key point detection information and the key point template information; screening the key point detection information based on the facial key point mapping relationship and the key point template information, to generate target key point information of the face image to be detected, in which target facial key points in the target key point information are facial key points of an un- blocked area in the face image to be detected.

According to a second aspect, an electronic device is provided. The electronic device includes at least one processor; and a memory communicatively connected with the at least one processor; in which the memory is configured to store instructions executable by the at least one processor. When the instructions are executed by the at least one processor, the at least one processor is configured to execute the method for detecting facial key points as described above.

According to a third aspect, a non-transitory computer readable storage medium having computer instructions is provided. When the computer instructions are performed by a computer, the computer is caused perform the method for detecting facial key points as described above.

It is understandable that, this part is not intended to recognize key or important features of embodiments of the disclosure, nor to limit the scope of the disclosure. Other features of the disclosure will be easily understood by the following description.

### BRIEF DESCRIPTION OF THE DRAWINGS

The drawings are used to well understand the technical solution, and do not constitute a limitation to the disclosure.

FIG. 1 is a schematic diagram according to a first embodiment of the disclosure.

FIG. 2 is a schematic diagram of key point detection information of a face image to be detected.

FIG. 3 is a schematic diagram of key point template information of a template face image.

FIG. 4 is a schematic diagram according to a second embodiment of the disclosure.

FIG. 5 is a schematic diagram of a third embodiment according to the disclosure.

FIG. 6 is a schematic diagram of evaluated position information of facial key points in the face image to be detected.

FIG. 7 is a schematic diagram of a fourth embodiment according to the disclosure.

FIG. 8 is a schematic diagram of a fifth embodiment according to the disclosure.

FIG. 9 is a block diagram illustrating an electronic device configured to perform a method for detecting facial key points according to embodiments of the disclosure.

### DETAILED DESCRIPTION

Embodiments of the disclosure will be described with reference to accompanying drawings, including various details of embodiments of the disclosure to facilitate understanding, which should be regarded as merely examples. Therefore, those of ordinary skill in the art should realize that various changes and modifications can be made to embodiments described herein without departing from the scope and spirit of the disclosure. Likewise, for clarity and conciseness, descriptions of well-known functions and structures are omitted in the following description.

Current detection technology of key points of a face usually achieves the key point detection function of any face image by building a deep neural network model and learning the key point distribution statistical characteristics of the face through the deep neural network learning model. However, when part of the face is blocked, the key point distribution statistical characteristics of the face will be disturbed or even destroyed, resulting in the inability to accurately detect the key points of the face.

In related arts, supervised learning methods are usually used to detect facial key points of an image containing a blocked face. This method adds additional labels to the training dataset to indicate whether the key points are blocked, so that the detection algorithm can identify whether each key point is blocked, and then effectively identify the blocked key points. However, this method requires additional manual labeling, which is costly, time-consuming, and poor in accuracy.

The disclosure provides a method for detecting facial key points to address a problem, existing in the prior arts, that detecting, through supervised learning methods, facial key points of an image where a human face is blocked requires additional manual annotations of training data, which is costly, time-consuming, and poor accuracy.

In the method for detecting facial key points according to the disclosure, the face image to be detected is obtained, key point detection information of the face image to be detected is extracted, key point template information of the template face image is obtained, a facial key point mapping relationship between the face image to be detected and the template face image is determined in combination with the key point detection information of the face image to be detected and the key point template information of the template face image, and target key point information of the face image to be detected is generated by filtering the key point detection information based on the facial key point mapping relationship and the key point template information. Target facial key points in the target key point information are facial key point of an un-blocked area in the face image to be detected. Therefore, the target key point information of the un-blocked area in the face image to be detected can be accurately identified without additional manual annotations, which saves cost and shortens processing time.

The following describes the method and device for detecting facial key points and an electronic device according to embodiments of the disclosure with reference to the accompanying drawings.

FIG. 1 is a schematic diagram according to a first embodiment of the disclosure. It is noteworthy that the execution subject of the method for detecting facial key points according to embodiments is a device for detecting facial key points. The device may be included in an electronic device to implement the detection of the target key point information of the un-blocked area in the face image to be detected. The electronic device may be any terminal device or server that can perform data processing, which is not limited in this disclosure.

As illustrated in FIG. 1, the method for detecting facial key points may include the following.

In step 101, a face image to be detected is obtained, and key point detection information of the face image to be detected is extracted.

The face image to be detected is an image that contains a human face and a part of the human face is blocked. As an example, the face image to be detected is an image containing a human face and an eye of the human face is blocked, or the face image to be detected is an image containing a human face and half of the mouth of the human face is blocked.

It is noteworthy that the method for detecting facial key points according to embodiments of the disclosure is also applicable to process an image containing a human face but the human face is not blocked. That is, the face image to be detected is an image containing a human face which is not blocked at all. Under this circumstance, the target facial key points in the target key point information of the face image to be detected that are generated through the method according to embodiments of the disclosure are all facial key points of the entire face area in the face image to be detected, and detection position information of these facial key points is accurate.

The facial key points include feature points at any position on the human face, such as the feature points of the eyes, mouth, nose, contour, corners of the eyes, and contours of the corners of the eyes.

The key point detection information may include detection position information of multiple facial key points of the face image to be detected.

In some embodiments, the key point detection information of the face image to be detected may be extracted in various ways.

For example, a key point detection model can be pre-trained, and the face image to be detected is input into the pre-trained key point detection model to extract the key point detection information of the face image to be detected. The key point detection model can be any deep neural network model, such as a convolutional neural network model, a recurrent neural network model, or other types of data processing models, which are not limited in this disclosure.

Alternatively, the key point detection information of the face image to be detected can be extracted by any other facial key point detection method in the related arts. The method for extracting the key point detection information of the face image to be detected is not limited in the disclosure.

In block 102, key point template information of a template face image is obtained.

The template face image can be any image that contains a human face and the entire human face is not blocked, and the face contained in the template face image can be a face of any person. It is noteworthy that the posture of the face in the template face image and the posture of the face in the face image to be detected may be the same or different, which is not limited in this disclosure. As an example, the face in the face image to be detected is a smiling face slightly deflected to the left, while the face in the template face image is an expressionless face facing in the front.

The key point template information may include template position information of multiple facial key points in the template face image.

In some embodiments, the key point template information of the template face image can be extracted in various ways.

For example, a key point detection model can be pre-trained, and the template face image is input into the pre-trained key point detection model, to extract the key point template information of the template face image. The key point detection model can be any deep neural network model, such as a convolutional neural network model, a recurrent neural network model, or other types of data processing models, which are not limited in this disclosure.

Alternatively, any other facial key point detection method in the related arts can be used to extract the key point template information of the template face image. The disclosure does not limit the method for extracting the key point template information of the template face image.

It is noteworthy that in embodiments of the disclosure, the manner for obtaining the key point detection information of the face image to be detected may be the same as or different from the manner for obtaining the key point template information of the template face image.

It is noteworthy that, in embodiments of the disclosure, the extracted key point detection information of the face image to be detected is in a one-to-one correspondence with the obtained key point template information of the template face image. The key point detection information being in a one-to-one correspondence with the key point template information means that the number of facial key points in the key point detection information is the same as the number of facial key points in the key point template information, and each facial key point in the key point detection information and a corresponding facial key point in the key point template information both correspond to the same face part.

In some embodiments of the disclosure, the facial key points of the same part can be uniquely annotated with the same identifier. For example, the identifier corresponding to the left corner of the left eye of a person is 1, the identifier corresponding to the right corner of the left eye of a person is 2, the identifier corresponding to the left corner of the right eye of a person is 3, and so on. It is noteworthy that the number of facial key points in the key point detection information and the number of facial key points in the key point template information can be set as needed, and 68 facial key points is taken as an example in this disclosure.

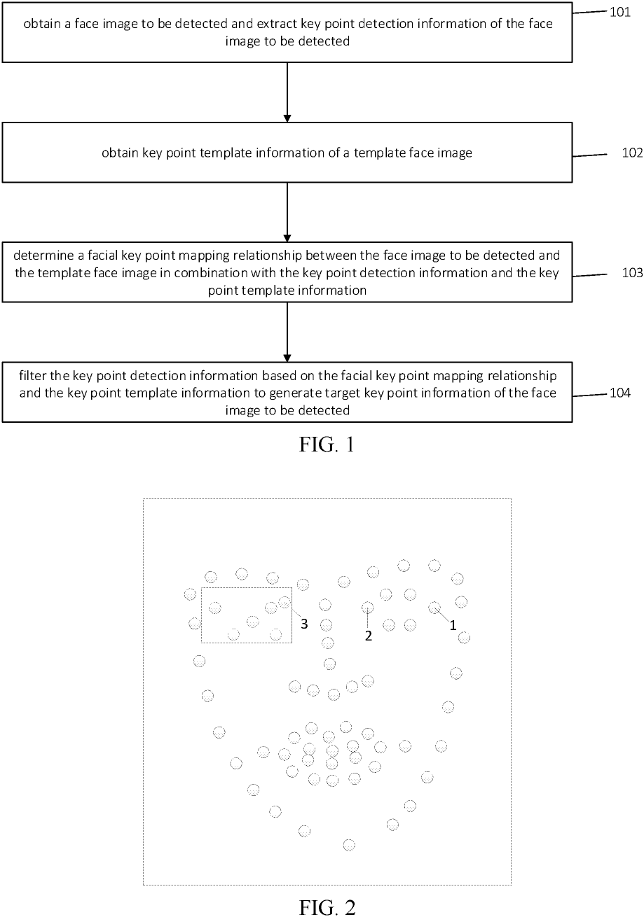

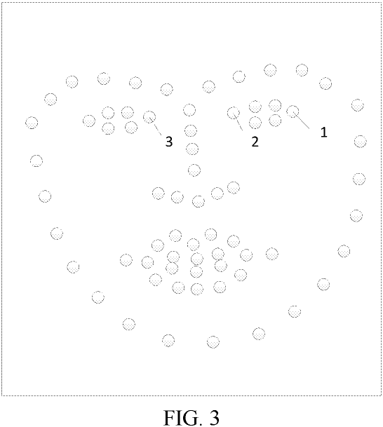

As illustrated in FIG. 2 and FIG. 3, FIG. 2 is a schematic diagram of key point detection information of a face image to be detected, and FIG. 3 is a schematic diagram of key point template information of a template face image. As illustrated in FIG. 2 and FIG. 3, the key point template information includes 68 facial key points, and the key point detection information also includes 68 facial key points. The left corner of the left eye of the person corresponds to the facial key point 1, the right corner of the left eye of the person corresponds to facial key point 2, the left corner of the right eye of the person corresponds to the facial key point 3, and so on.

In some embodiments, taking the use of the pre-trained key point detection model to extract the key point information as an example, a key point detection model that can detect a specific number of key points at specific positions can be pre-trained, and the pre-trained key point detection model can be used to obtain the key point detection information of the face image to be detected and the key point template information of the template face image in a one-to-one correspondence.

It is understandable that because the template face image is a face image where the face contained therein is not blocked, the key point template information of the template face image includes template position information of all facial key points of the face. Since the face image to be detected is a face image where part of the face contained therein is blocked, the key point detection information of the face image to be detected includes the detection position information of the facial key points of the blocked area and the detection position information of the facial key points of the un-blocked area, but the shape formed by the facial key points of the blocked area is seriously deformed.

For example, as illustrated in FIG. 2 and FIG. 3, since the template face image is an image where the face is not blocked, the facial key points included in the key point template information of the template face image are all the facial key points of the face, namely 68 facial key points, while since the right eye of the person is blocked in the face image to be detected, although the key point detection information of the face image to be detected can be extracted through the step 101, the shape formed by the extracted facial key points of the blocked area is completely deformed, and the detection position information of these facial key points in the blocked area is completely wrong.

In step 103, a facial key point mapping relationship between the face image to be detected and the template face image is determined in combination with the key point detection information and the key point template information.

The facial key point mapping relationship is a mapping relationship between the detection position information of facial key points of the un-blocked area in the face image to be detected and the template position information of facial key points of the corresponding same face part in the template face image.

In step 104, the key point detection information is filtered based on the facial key point mapping relationship and the key point template information to generate target key point information of the face image to be detected.

Target facial key points in the target key point information are facial key points of the un-blocked area in the face image to be detected.

It is understandable that, in some embodiments of the disclosure, since the facial key point mapping relationship is the mapping relationship between the detection position information of the facial key points of the un-blocked area in the face image to be detected and the template position information of the facial key points of the corresponding same face part in the template face image, and the detection position information of the facial key points of the un-blocked area is basically correct, that is, the facial key point mapping relationship is the mapping relationship between the template position information of the facial key points of a face part and the basically correct detection position information of the same face part, after the facial key point mapping relationship is determined, the actual positions of the facial key points of a face part that is included in both the template face image and the face image to be detected can be predicted based on the facial key point mapping relationship and the template position information of each facial key point in the key point template information of the template face image.

In detail, based on the facial key point mapping relationship and the template position information of each facial key point in the key point template information of the template face image, the actual positions of the facial key points of the face part that is included in both the template face image and the face image to be detected are predicted, and the evaluated position information of the facial key points of the face part that is included in both the template face image and the face image to be detected can be determined. Since the detection position information of the facial key points of the un-blocked area is basically correct, the detection position information of the facial key points of the un-blocked area is consistent with the evaluated position information of the facial key points of the same face part. Therefore, in embodiments of the disclosure, for each facial key point in the face image to be detected, it can be determined whether the evaluated position information of the facial key point is consistent with the detection position information of the facial key point by comparing the evaluated position information of the facial key point and the detection position information of the facial key point. If the detection position information of the facial key point in the face image to be detected is consistent with the evaluated position information, the facial key point can be determined as a facial key point of the un-blocked area, that is, the target facial key points. In this way, the target facial key points of the un-blocked area can be obtained by filtering the key point detection information of the face image to be detected, and the target key point information of the face image to be detected can be generated based on the detection position information corresponding to the facial key points of the un-blocked area in the key point detection information.

With the method for detecting facial key points according to this disclosure, after acquiring the key point detection information of the face image to be detected and the key point template information of the template face image, the facial key point mapping relationship between the face image to be detected and the template face image is determined in combination with the key point detection information and the key point template information, and the key point detection information is filtered based on the facial key point mapping relationship and the key point template information to generate the target facial key points in the face image to be detected, in which the target facial key points in the target key point information are the facial key points of the un-blocked area in the face image to be detected. Since the facial key point mapping relationship is the mapping relationship between the template position information of a face part and the basically correct detection position information of the facial key points of the same face part, using the facial key point mapping relationship, the evaluated position information of the facial key points in the face image to be detected can be accurately determined, and further the target key point information can be accurately generated through the filtering processing. In addition, since the facial key points of the un-blocked area in the face image to be detected are determined based on the facial key point mapping relationship and the target key point information of the face image to be detected is generated based on the detection position information of the facial key points of the un-blocked area, necessary data labeling when training the key point detection model is required and no additional manual labeling is required, thus saving the cost and time spent on manual labeling.

With the method for detecting facial key points according to embodiments of the disclosure, the face image to be detected is obtained, the key point detection information of the face image to be detected is extracted, key point template information of the template face image is obtained, the facial key point mapping relationship between the face image to be detected and the template face image is determined in combination with the key point detection information of the face image to be detected and the key point template information of the template face image, and the target key point information of the image to be detected is generated by filtering the key point detection information based on the facial key point mapping relationship and the key point template information. Target facial key points in the target key point information are facial key points of an un-blocked area in the face image to be detected. Therefore, the target key point information of the un-blocked area in the face image to be detected can be accurately identified without additional manual annotations, which saves cost and shortens time.

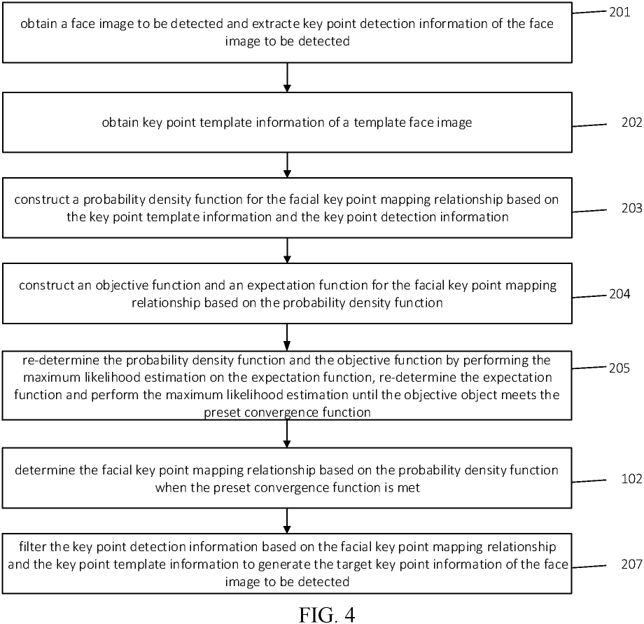

From the above analysis, in this disclosure, after acquiring the key point detection information of the face image to be detected and the key point template information of the template face image, the facial key point mapping relationship between the image to be detected and the template face image is determined in combination with the key point detection information and the key point template information, and the key point detection information is filtered based on the facial key point mapping relationship and the key point template information to generate the facial key point information of the un-blocked area in the face image to be detected. As illustrated in FIG. 4, the process of generating the facial key point mapping relationship between the face image to be detected and the template face image in embodiments of the disclosure will be described in detail below.

FIG. 4 is a schematic diagram according to a second embodiment of the disclosure. As illustrated in FIG. 4, the method for detecting facial key points according to the disclosure application may include the following.

In step 201, a face image to be detected is obtained and key point detection information of the face image to be detected is extracted.

In block 202, key point template information of the template face image is obtained.

For the specific implementation process and principles of the foregoing blocks 201-202, reference may be made to the detailed description of the foregoing embodiments, which will not be repeated here.

In step 203, a probability density function is established for the facial key point mapping relationship based on the key point template information and the key point detection information.

The probability density function may be determined by distribution information of the facial key point mapping relationship of the blocked area in the face image to be detected and distribution information of the facial key point mapping relationship of the un-blocked area in the face image to be detected.

It is understandable that, in embodiments of the disclosure, when the face image to be detected is a face image including a blocked area and an un-blocked area, based on the key point template information and the key point detection information, the facial key point mapping relationship can be established between the detection position information of the facial key points of the blocked area and the template position information of the facial key points of the same face part as the blocked area in the key point template information is established, i.e., the facial key point mapping relationship of the blocked area, and the facial key point mapping relationship between the detection position information of the facial key points of the un-block area and the template position information of the facial key points of the same face part as the un-blocked area in the key point template information is established, i.e., the facial key point mapping relationship of the un-blocked area. According to distribution information of the facial key point mapping relationship of the blocked area and the distribution information of the facial key point mapping relationship of the un-blocked area, the probability density function is constructed.

In some embodiments, the distribution information of the facial key point mapping relationship of the blocked area in the face image to be detected may be uniform distribution information, and the distribution information of the facial key point mapping relationship of the un-blocked area in the face image to be detected may be Gaussian Mixture Distribution information.

In some examples, the calculation formula of the probability density function may be formula (1):

$$p \left(x\right) = ω \frac{1}{N} + \left(1 - ω\right) {\sum }_{k = 1}^{N} p \left(x \vert k\right)$$

where x represents the key point detection information of the face image to be detected, ω represents the proportion of the blocked area in the face image to be detected,

$$\frac{1}{N}$$

represents the uniform distribution information, and p(x | k) represents Gaussian distribution information.

In step 204, an objective function and an expectation function are constructed for the facial key point mapping relationship according to the probability density function.

In step 205, maximum likelihood estimation is performed on the expectation function, and the probability density function and the objective function are re-determined according to the estimation result, the expectation function is re-determined and the maximum likelihood estimation is performed, until the new objective function meets a preset convergence condition.

In step 206, the facial key point mapping relationship is determined according to the probability density function that is determined when the preset convergence condition is satisfied.

The convergence condition can be set as required.

It is understandable that, in embodiments of the disclosure, solving the facial key point mapping relationship is the process of solving the above-mentioned probability density function.

In specific implementation, the objective function for the facial key point mapping relationship can be constructed according to the probability density function, and the expectation function can be constructed according to the probability density function and the objective function. The maximum likelihood estimation can be performed on the expectation function to determine parameter values in the objective function. According to the determined parameter values, the probability density function and the objective function are re-determined, the expectation function is re-determined and the maximum likelihood estimation is performed on the re-determined expectation function, until the objective function satisfies the preset convergence condition, so that according to the probability density function determined when the objective function satisfies the preset convergence function, the facial key point mapping relationship can be determined.

In some examples, performing the maximum likelihood estimation can be achieved by using a maximum likelihood function, or by using a minimized negative log-likelihood function, which is not limited in this disclosure.

In some examples, the correspondence between the template position information of the facial key points in the key point template information and the evaluated position information of the facial key points in the key point detection information can be represented by radial transformation, then the objective function for the facial key point mapping relationship in this disclosure can be in the form of formula (2):

$$Q \left(R , t , s , {σ}^{2}\right) = \frac{1}{2 {σ}^{2}} {\sum }_{k = 1}^{N} {P}^{o l d} \left(k \vert x\right) {\left‖{x}_{k} - f \left({y}_{k}\right)\right‖}^{2} + {N}_{P} log {σ}^{2}$$

where, f(yₖ) = sRyₖ +t , R, t, s are radiation transformation parameters, R is the rotation matrix, t is the displacement matrix, s is the scaling matrix, σ² is the Gaussian distribution variance, P^{old} is the posterior probability of the Gaussian mixture model calculated with the last iteration parameters, N represents the number of facial key points, N_{P} represents the mixture Gaussian distribution sum, xₖ represents the detection position information of the k^{th} facial key point in the key point detection information, and yₖ represents the template position information of the facial key point of the face part that is the same as the k^{th} facial key point in the key point detection information, f(yₖ) represents the evaluated position information of the k^{th} facial key point in the key point detection information.

In some examples, the expectation function may be in the form of the following formula (3):

$${p}_{m m} = \frac{exp \left(- \frac{1}{2 {σ}^{2}} {\left‖{x}_{k} - f \left({y}_{k}\right)\right‖}^{2}\right)}{{\sum }_{k = 1}^{N} exp \left(- \frac{1}{2 {σ}^{2}} {\left‖{x}_{k} - f \left({y}_{k}\right)\right‖}^{2}\right) + 2 π {σ}^{2} \frac{ω}{1 - ω}}$$

In some embodiments, when the probability density function, the objective function, and the expectation function are in the forms of the above formulas (1), (2), and (3) respectively, the step 205 can be specifically implemented in the following manner.

First, perform initialization, and let B = I , t = 0, and 0 < ω < 1, where B = sR, and I is the identity matrix.

Then, when B = I, t = 0, and 0 < ω < 1, perform the maximum likelihood estimation on the expectation function shown in formula (3), and solve for B, t and σ².

Specifically,

$${μ}_{x} = \frac{1}{{1}^{T} P 1} {X}^{T} P 1 , {μ}_{y} = \frac{1}{{1}^{T} P 1} {Y}^{T} P 1$$

$$\hat{X} = X - 1 {μ}_{x}^{T} , \hat{Y} = Y - 1 {μ}_{y}^{T}$$

$$B = \left(\hat{X} {P}^{T} \hat{Y}\right) {\left(\hat{Y} d \left(P 1\right) \hat{Y}\right)}^{- 1}$$

$$t = {μ}_{x} - B {μ}_{y}$$

$${σ}^{2} = \frac{1}{{N}_{P}} \left(t r \left(\hat{X} d \left(P 1\right) \hat{X}\right) - t r \left(\hat{X} {P}^{T} \left(\hat{Y} {B}^{T}\right)\right)\right)$$

Next, according to the calculated B, t and

$${σ}^{2} ,$$

re-determine the probability density function and the objective function, re-determine the expectation function, and perform the maximum likelihood estimation on the re-determined expectation function, and solve for B, t and

$${σ}^{2}$$

again. Further, the probability density function and the objective function are re-determined again, the expectation function is re-determined again, and the maximum likelihood estimation is performed on the re-determined expectation function, and the above process is repeated until the objective function meets the preset convergence condition.

Furthermore, according to the radiation transformation parameters R, t, s that are determined when the objective function meets the preset convergence condition, the facial key point mapping relationship can be obtained.

It is understandable that in this disclosure, the probability density function is constructed for the facial key point mapping relationship according to the key point template information and the key point detection information. The probability density function is determined from the distribution information of the facial key point mapping relationship of the blocked area and the distribution information of the facial key point mapping relationship of the un-block area in the face image to be detected. According to the probability density function, the objective function and the expectation function are constructed for the facial key point mapping relationship, and the maximum likelihood estimation is performed on the expectation function to determine the facial key point mapping relationship. Since the maximum likelihood estimation determines the radiation transformation parameters when the facial key point mapping relationship having the maximum probability appear, and the facial key point mapping relationship is determined based on the probability density function when the objective function converges, the facial key point mapping relationship determined in the above manner is accurate and reliable. In addition, by setting the distribution information of the facial key point mapping relationship of the blocked area and the distribution information of the facial key point mapping relationship of the un-blocked area in the face image to be detected correspond to different types of distribution information, the probability density function is determined based on the different types of distribution information corresponding to distribution information of the facial key point mapping relationship of the blocked area and the distribution information of the facial key point mapping relationship of the un-blocked area, and the facial key point mapping relationship is determined according to the probability density function, which further improve the accuracy and reliability of the determined facial key point mapping relationship.

In step 207, the key point detection information is filtered according to the facial key point mapping relationship and the key point template information to generate target key point information of the face image to be detected.

The target facial key points in the target key point information are the facial key points of the un-blocked area in the face image to be detected.

For the specific implementation process and principle of the foregoing step 207, reference may be made to the relevant description of the foregoing embodiment, which will not be repeated here.

It is understandable that since the facial key point mapping relationship determined in this disclosure is accurate and reliable, and the target key point information of the face image is generated by filtering the key point detection information according to the facial key point mapping relationship and key point template information, the accuracy and reliability of the target key point information of the face image to be detected can be improved.

With the method for detecting facial key points according to this disclosure, the face image to be detected is obtained, the key point detection information of the face image to be detected is extracted, the key point template information of the template face image is obtained, the probability density function for the facial key point mapping relationship is constructed based on the key point template information and the key point detection information, the objective function and the expectation function are constructed for the facial key point mapping relationship according to the probability density function, the maximum likelihood estimation is performed on the expectation function, the probability density function and the objective function are re-determined based on the estimation result, the expectation function is re-determined and the maximum likelihood estimation is performed on the re-determined expectation function until the objective function meets the preset convergence conditions, the facial key point mapping relationship is determined based on the probability density function when the preset convergence conditions are met, and the key point detection information is filtered based on the facial key point mapping relationship and the key point template information to generate target key point information of the face image to be detected. Therefore, the target key point information of the un-blocked area in the face image to be detected can be accurately identified without additional manual annotation, which saves cost and time.

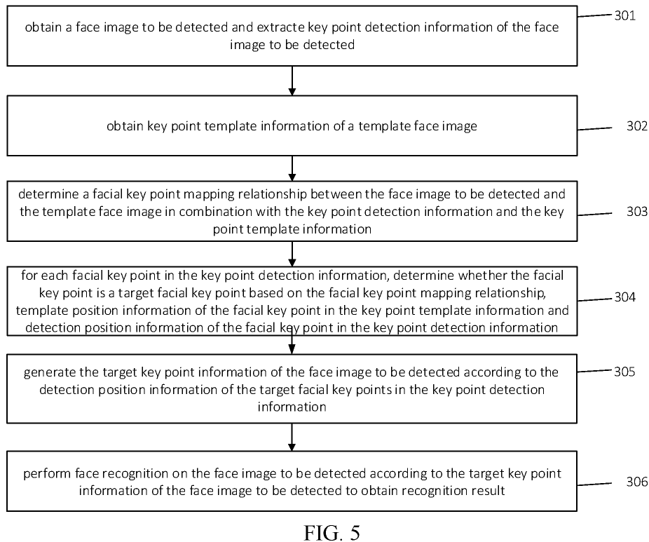

From the above analysis, in embodiments of the disclosure, after determining the facial key point mapping relationship between the face image to be detected and the template face image, the key point detection information can be filtered according to the facial key point mapping relationship and the key point template information to generate the facial key point information of the un-blocked area in the face image to be detected. As illustrated in FIG. 5, generating the facial key point information of the un-blocked area in the face image to be detected by filtering the key point detection information according to the facial key point mapping relationship and the key point template information will be described in detail below.

FIG. 5 is a schematic diagram of a third embodiment according to the disclosure. As illustrated in FIG. 5, the method for detecting facial key points according to the disclosure may include the following.

In step 301, a face image to be detected is obtained, and key point detection information of the face image to be detected is extracted.

In step 302, key point template information of the template face image is obtained.

In step 303, a facial key point mapping relationship between the face image to be detected and the template face image is determined in combination with the key point detection information and the key point template information.

For the specific implementation process and principles of the foregoing steps 301-303, reference may be made to the description of the foregoing embodiment, which will not be repeated here.

In step 304, for each facial key point in the key point detection information, it is determined whether the facial key point is a target facial key point according to the facial key point mapping relationship, the template position information of the facial key point in the key point template information, and the detection position information of the facial key point in the key point detection information.

In detail, since the facial key point mapping relationship is a mapping relationship between the template position information of the facial key points of a face part and the basically correct detection position information of the facial key points of the same face part, the actual positions of the facial key points of a face part that is included in both the template face image and the face image to be detected can be predicted according to the facial key point mapping relationship and the template position information of the facial key points in the key point template information.

In detail, according to the facial key point mapping relationship and the template position information of each facial key point in the key point template information of the template face image, the actual locations of the facial key points of the same face part that is included in both the face image to be detected and the template face image can be predicted, and the evaluated position information of the facial key points of the same face part that is included in both the face image to be detected and the template face image can be determined. In addition, since the key point template information of the template face image corresponds to the key point detection information of the face image to be detected one by one, both the detection position information of a facial key point in the key point detection information and the evaluated position information of a facial key point correspond to the facial key point of the same face part, and for each facial key point in the key point detection information, it may be determined whether the facial key point is a target key point based on the evaluated position information and the detection position information of the facial key point.

That is, the step 304 may include for each facial key point in the key point detection information, according to the template position information of the facial key point and the facial key point mapping relationship, determining the evaluated position information of the facial key point; and determining whether the facial key point is a target facial key point according to the evaluated position information and the detection position information of the facial key point.

It is understandable that for each facial key point in the key point detection information, the evaluated position information of the facial key point can be determined according to the template position information of the facial key point and the facial key point mapping relationship. In embodiments of the disclosure, it is possible to determine the evaluated position information of the facial key points of the un-blocked area in the face image to be detected and determine the evaluated position information of the facial key points of the blocked area in the face image to be detected.

In specific implementation, since the target facial key points are the facial key points of the un-blocked area in the face image to be detected, and the detection position information of the facial key points of the un-blocked area in the key point detection information is basically correct, the detection position information of the facial key points of the un-block area is consistent with the evaluated position information of the facial key points of the same face part. In embodiments of the disclosure, in order to generate the target key point information by filtering the key point detection information of the face image to be detected, after determining the evaluated position information of each facial key point, for each facial key point in the key point detection information, it can be determined whether the evaluated position information of the facial key point is consistent with the detection position information of the facial key point. If the detection position information of the facial key point is consistent with the evaluated position information of the facial key point, it can be determined that the facial key point is a target facial key point. If the detection position information of the facial key point is inconsistent with the evaluated position information of the facial key point, it can be determined that the facial key point is a non-target facial key point.

Therefore, by determining, for each facial key point in the key point detection information, the evaluated position information of the facial key point according to the template position information of the facial key point and the facial key point mapping relationship, the evaluated position information of the facial key points of the un-blocked area in the face image to be detected and the evaluated position information of the facial key points of the blocked area can be determined, and for each facial key point in the face image to be detected, it can be determined whether the facial key point is a target facial key point according to the evaluated position information and the detection position information of the facial key point, thereby accurately obtaining the target facial key points of the un-blocked area in the face image to be detected through the filtering processing.

In a specific implementation, a distance threshold can be preset. For each facial key point in the key point detection information, it can be determined whether the detection position information of the facial key point is the same as the evaluated position information of the facial key point based on whether a distance between the detection position information of the facial key point and the evaluated position information of the facial key point is less than or equal to the preset distance threshold. In response to determining that the distance between the detection position information of a facial key point and the evaluated position information of the facial key point is less than or equal to the preset distance threshold, it can be determined that the detection position information of the facial key point is consistent with the evaluated position information and it can be determined that the facial key point is a target facial key point. In response to determining that the distance between the detection position information of a facial key point and the evaluated position information of the facial key point is greater than the preset distance threshold, it can be determined that the detection position information of the facial key point is inconsistent with the evaluated position information, and it can be determined that the facial key point is a non-target facial key point.

That is, according to the evaluated position information and the detection position information of the facial key point, determining whether the facial key points is the target facial key point may include: determining the distance between the evaluated position information and the detection position information of the facial key point; determining that the facial key point is a target facial key point in response to determining that the distance is less than or equal to the preset distance threshold; and determining that the facial key point is a non-target facial key point in response to determining that the distance is greater than the preset distance threshold.

The distance between the evaluated position information and the detection position information can be any distance type that can characterize the distance between two points, such as Euclidean distance, cosine distance, or the like.

The preset distance threshold can be set according to needs. The smaller the preset distance threshold is, the more accurate the target key point information of the face image to be detected generated by filtering the detection position information is. Therefore, in practical applications, the preset distance threshold can be flexibly set based on the requirements on the accuracy of the generated target key point information.

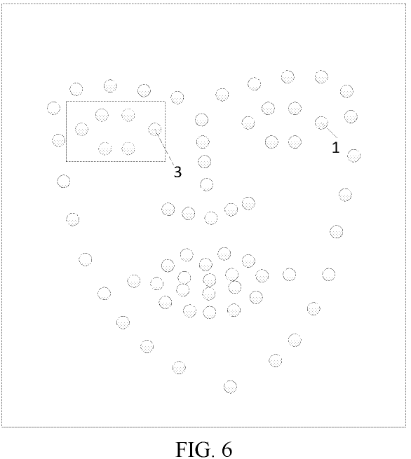

For example, as illustrated in FIG. 2 and FIG. 3, FIG. 2 is a schematic diagram of key point detection information of a face image to be detected, and FIG. 3 is a schematic diagram of key point template information of a template face image. In embodiments of the disclosure, for each facial key point in the key point detection information, the evaluated position information of the facial key point can be determined according to the template position information of the facial key point and the facial key point mapping relationship. FIG. 6 is a schematic diagram of evaluated position information of each facial key point in the face image to be detected. For each facial key point in the key point detection information, the distance between the evaluated position information and the detection position information can be determined and the distance is compared with the preset distance threshold. Taking the facial key point 1 of the left corner of the left eye of a person as an example, the distance between the evaluated position information of the facial key point 1 illustrated in FIG. 6 and the detection position information of the facial key point 1 illustrated in FIG. 2 is compared with the preset distance threshold to obtain a comparison result that the distance between the evaluated position information of the facial key point 1 and the detection position information of the facial key point 1 is less than the preset distance information, to determine that the facial key point 1 in the key point detection information of the face image to be detected is a target key point. Taking the facial key point 3 of the left corner of the right eye of a person as an example, the distance between the evaluated position information of the facial key point 3 illustrated in FIG. 6 and the detection position information of the facial key point 3 illustrated in FIG. 2 can be compared with the preset distance threshold to obtain a comparison result that the distance between the evaluated position information of the facial key point 3 and the detection position information of the facial key point 3 is greater than the preset distance threshold, to determine that the facial key point 3 in the key point detection information of the face image to be detected is a non-target key point. Thus, it can be determined whether each facial key point in the key point detection information is a target key point.

By setting the preset distance threshold, and for each facial key point in the key point detection information, it is determined whether the facial key point is a target facial key point based on the relationship between the preset distance threshold and the distance between the evaluated position information of the facial key point and the detection position information of the facial key point, such that it can be accurately determined whether the facial key points in the key point detection information of the face image to be detected are the target facial key point.

In step 305, target key point information of the face image to be detected is generated according to the detection position information of the target facial key points in the key point detection information.

In detail, after determining whether each facial key point in the key point detection information is a target facial key point, the detection position information of the target facial key points can be obtained by filtering the key point detection information, and the target key point information of the face image to be detected is generated based on the detection position information of the target facial key points.

For each facial key point in the key point detection information, by determining whether the facial key point is a target facial key point according to the facial key point mapping relationship, the template position information of the facial key point in the key point template information and the detection position information of the facial key point in the key point detection information, the target key point information of the face image to be detected is generated according to the detection position information of the target facial key points in the key point detection information, so as to accurately determine the facial key points of the un-blocked area in the face image to be detected, the positions of the facial key points and the number of the facial key points. The entire process does not require additional manual labeling, which saves costs and takes a short time.

It is understandable that after generating the target key point information of the face image to be detected, the target key point information can be used to realize functions such as face recognition of the face image to be detected. That is, after the step 305, the may further include the following.

In step 306, face recognition is performed on the face image to be detected according to the target key point information of the face image to be detected to obtain a recognition result.

It is noteworthy that in addition to the face recognition, the target key point information of the face image to be detected determined in embodiments of the disclosure can be applied to various scenarios.

For example, the target key point information of the face image to be detected can be generated according to embodiments of the disclosure to realize the special effect or editing process of the specific target key points in the face image to be detected. For example, the positions of target key points corresponding to the eyes can be determined based on the target key point information of the face image to be detected, such that a glasses special effect can be applied to the eye area or the eyes can be enlarged. Alternatively, the positions of the target key points corresponding to the eyebrows can be determined based on the target key point information of the face image to be detected, such that the eyebrows can be thickened.

It is understandable that by performing the face recognition on the face image to be detected based on the target key point information of the face image to be detected, and obtaining the recognition result, it is possible to realize the face recognition function using the determined target key point information of the face image to be detected. Since the target key point information generated by the method for detecting facial key points according to embodiments of the disclosure is accurate and reliable, when the target key point information generated by this method is used for the face recognition, the recognition result is also accurate and reliable.

With the method for detecting facial key points according to the disclosure, the face image to be detected is obtained, the key point detection information of the face image to be detected is extracted, the key point template information of the template face image is obtained, the facial key point mapping relationship between the face image to be detected and the template face image is determined in combination with key point detection information and the key point template information, it is determined whether each facial key point in the key point detection information is a target facial key point according to the facial key point mapping relationship, the template position information of the facial key point in the key point template information and the detection position information of the facial key point in the key point detection information, and the target key point information of the face image to be detected is generated according to the detection position information of the target facial key points in t eh key point detection information, and the face recognition is performed on the face image to be detected according to the target key point information of the face image to be detected to obtain the recognition result. Therefore, the target key point information of the un-blocked area in the face image to be detected can be accurately identified without additional manual annotation, and the face recognition is performed on the face image to be detected based on the facial key point information of the un-blocked area, which saves cost and shortens time.

In order to implement the embodiments described in FIG. 1 to FIG. 6, embodiments of the disclosure further provides a device for detecting facial key points.

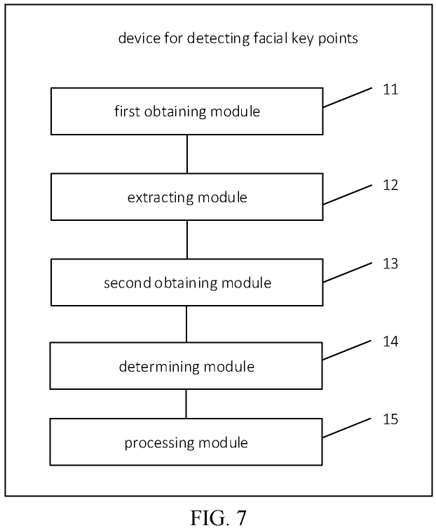

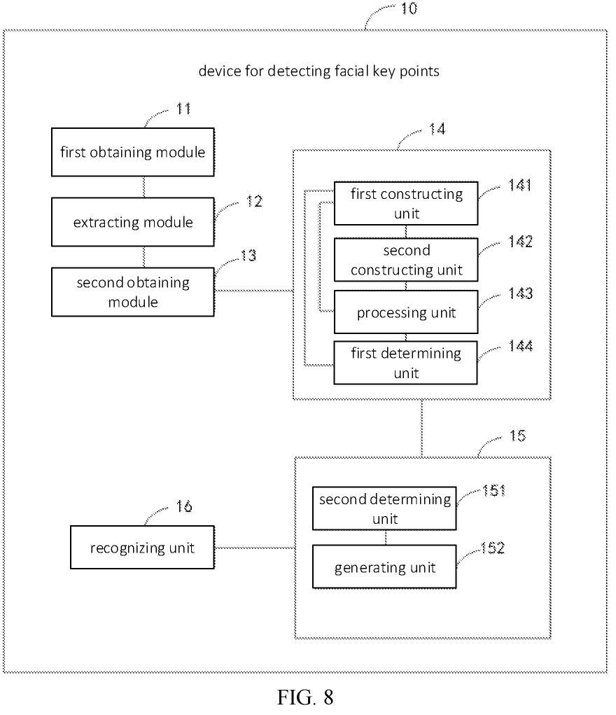

FIG. 7 is a schematic diagram of a fourth embodiment according to the disclosure. As illustrated in FIG. 7, the device 10 for detecting facial key points includes a first obtaining module 11, an extracting module 12, a second obtaining module 13, a determining module 14, and a processing module 15.

The device for detecting facial key points according to embodiments of the disclosure can execute the method for detecting facial key points according to above-mentioned embodiments of this disclosure. The device for detecting facial key points can be included in an electronic device to detect target key point information of an un-blocked area in the face image to be detected. The electronic device may be any terminal device or server that can perform data processing, which is not limited in this disclosure.

The first obtaining module 11 is configured to obtain a face image to be detected.

The extracting module 12 is configured to extract key point detection information of the face image to be detected.

The second obtaining module 13 is configured to obtain key point template information of the template face image.

The determining module 14 is configured to determine a facial key point mapping relationship between the face image to be detected and the template face image in combination with the key point detection information and the key point template information.

The processing module 15 is configured to filter the key point detection information according to the facial key point mapping relationship and the key point template information to generate target key point information of the face image to be detected, in which target facial key points in the target key point information are facial key points of an un-block area in the face image to be detected.

It is noteworthy that the description of the method for detecting facial key points in the foregoing embodiment is also applicable to the device 10 for detecting facial key points in the embodiments of the disclosure, and will not be repeated here.

With the device for detecting facial key points according to embodiments of the disclosure, the face image to be detected is obtained, the key point detection information of the face image to be detected is extracted, key point template information of the template face image is obtained, the facial key point mapping relationship between the face image to be detected and the template face image is determined in combination with the key point detection information of the face image to be detected and the key point template information of the template face image, and the target key point information of the image to be detected is generated by filtering the key point detection information based on the facial key point mapping relationship and the key point template information. Target facial key points in the target key point information are facial key points of an un-blocked area in the face image to be detected. Therefore, the target key point information of the un-blocked area in the face image to be detected can be accurately identified without additional manual annotations, which saves cost and shortens time.

FIG. 8 is a schematic diagram of a fifth embodiment according to the disclosure.

As illustrated in FIG. 8, on the basis of FIG. 7, the determining module 14 in the device 10 for detecting facial key points according to the disclosure may specifically include a first constructing unit 141, a second constructing unit 142, a processing unit 143, and a first determining unit 144.

The first constructing unit 141 is configured to construct a probability density function for the facial key point mapping relationship according to the key point template information and the key point detection information. The probability density function is determined by distribution information of the facial key point mapping relationship of the blocked area in the face image to be detected and distribution information of the facial key point mapping relationship of the un-blocked area in the face image to be detected.

The second constructing unit 142 is configured to construct an objective function and an expectation function for the facial key point mapping relationship according to the probability density function.

The processing unit 143 is configured to perform maximum likelihood estimation on the expectation function, re-determine the probability density function and the objective function according to the estimation result, re-determine the expectation function, and perform the maximum likelihood estimation until the objective function meets the preset convergence condition.

The first determining unit 144 is configured to determine the facial key point mapping relationship according to the probability density function determined when the preset convergence condition is satisfied.

In some examples, the distribution information of the facial key point mapping relationship of the blocked area in the face image to be detected is uniform distribution information; and the distribution information of the facial key point mapping relationship of the un-block area in the face image to be detected is Gaussian Mixture Distribution information.

In some examples, the calculation formula of the probability density function is,

$$p \left(x\right) = ω \frac{1}{N} + \left(1 - ω\right) {\sum }_{n = 1}^{N} p \left(x \vert n\right)$$

where, x represents the key point detection information of the face image to be detected, ω represents the proportion of the blocked area in the face image to be detected,

$$\frac{1}{N}$$

represents the uniform distribution information, and p(x|n) represents Gaussian distribution information.

In some examples, as illustrated in FIG. 8, the processing module 15 may include a second determining units 151 and a generating unit 152.

The second determining unit 151 is configured to determine, for each facial key point in the key point detection information, whether the facial key point is a target facial key point according to the facial key point mapping relationship, the template position information of the facial key point in the key point template information, and the detection position information of the facial key point in the key point detection information.

The generating unit 152 is configured to generate target key point information of the face image to be detected according to the detection position information of the target face key points in the key point detection information.

In some examples, the above-mentioned second determining unit 151 may include a first determining subunit and a second determining subunit.

The first determining subunit is configured to determine, for each facial key point in the key point detection information, evaluated position information of the facial key point according to the template position information of the facial key point and the facial key point mapping relationship.

The second determining subunit is configured to determine whether the facial key point is a target facial key point according to the evaluated position information and the detection position information of the facial key point.

In some examples, the second determining subunit is configured to determine a distance between the evaluated position information and the detection position information of the facial key point; in response to determining that the distance is less than or equal to a preset distance threshold, determine the facial key point as a target facial key point; and in response to determining that the distance is greater than the preset distance threshold, determine that the facial key point is a non-target facial key point.

In some examples, as illustrated in FIG. 8, on the basis of FIG. 7, the device 10 for detecting facial key points according to the disclosure may further include a recognizing module 16 configured to perform face recognition on the face image to be detected based on the target key point information of the face image to be detected to obtain a recognition result.

It is noteworthy that the description of the method for detecting facial key points in the foregoing embodiment is also applicable to the device 10 for detecting facial key points in embodiments of the disclosure, and will not be repeated here.

With the device for detecting facial key points according to embodiments of the disclosure, the face image to be detected is obtained, the key point detection information of the face image to be detected is extracted, the key point template information of the template face image is obtained, the facial key point mapping relationship between the face image to be detected and the template face image is determined in combination with the key point detection information of the face image to be detected and the key point template information of the template face image, and the target key point information of the image to be detected is generated by filtering the key point detection information based on the facial key point mapping relationship and the key point template information. Target facial key points in the target key point information are facial key points of an un-blocked area in the face image to be detected. Therefore, the target key point information of the un-blocked area in the face image to be detected can be accurately identified without additional manual annotations, which saves cost and shortens time.

According to embodiments of the disclosure, there is further provided an electronic device and a readable storage medium.

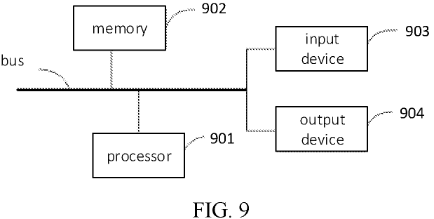

FIG. 9 is a block diagram illustrating an electronic device configured to perform a method for detecting facial key points according to embodiments of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 9, the electronic device includes: one or more processors 901, a memory 902, and interfaces for connecting various components, including a high-speed interface and a low-speed interface. Various components are connected to each other with different buses, and may be mounted on a common main board or mounted in other ways as required. The processor may process instructions executed within the electronic device, including instructions stored in or on the memory to display graphical information of the GUI (graphical user interface) on an external input/output device (such as a display device coupled to an interface). In other implementations, multiple processors and/or multiple buses may be used together with multiple memories if necessary. Similarly, multiple electronic devices may be connected, and each electronic device provides a part of necessary operations (for example, as a server array, a group of blade servers, or a multiprocessor system). In FIG. 9, one processor 901 is taken as an example.

The memory 902 is a non-transitory computer-readable storage medium according to embodiments of the disclosure. The memory is configured to store instructions executable by at least one processor, to cause the at least one processor to execute a method for detecting facial key points according to embodiments of the disclosure. The non-transitory computer-readable storage medium according to embodiments of the disclosure is configured to store computer instructions. The computer instructions are configured to enable a computer to execute a method for detecting facial key point according to embodiments of the disclosure.

As the non-transitory computer-readable storage medium, the memory 902 may be configured to store non-transitory software programs, non-transitory computer executable programs and modules, such as program instructions/modules (such as, the first obtaining module 11, the extracting module 12, the second obtaining module 13, the determining module 14, the processing module 15 as illustrated in FIG. 7 and the recognizing module as illustrated in FIG. 8) corresponding to a method for detecting facial key points according to embodiments of the disclosure. The processor 901 executes various functional applications and data processing of the server by operating non-transitory software programs, instructions and modules stored in the memory 902, that is, implements a method for detecting facial key points according to embodiments of the disclosure.

The memory 902 may include a storage program region and a storage data region. The storage program region may store an application required by an operating system and at least one function. The storage data region may store data created by implementing the method for detecting facial key points through the electronic device. In addition, the memory 902 may include a high-speed random-access memory and may also include a non-transitory memory, such as at least one disk memory device, a flash memory device, or other non-transitory solid-state memory device. In some embodiments, the memory 902 may optionally include memories remotely located to the processor 901 which may be connected to the electronic device configured to implement a method for detecting facial key points via a network. Examples of the above network include, but are not limited to, the Internet, an intranet, a local area network, a mobile communication network and combinations thereof.

The electronic device configured to implement a method for detecting facial key points may also include: an input device 903 and an output device 904. The processor 901, the memory 902, the input device 903, and the output device 904 may be connected through a bus or in other means. In FIG. 9, the bus is taken as an example.

The input device 903 may be configured to receive inputted digitals or character information, and generate key signal input related to user setting and function control of the electronic device configured to implement a method for detecting facial key points, such as a touch screen, a keypad, a mouse, a track pad, a touch pad, an indicator stick, one or more mouse buttons, a trackball, a joystick and other input device. The output device 904 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be a touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general-purpose programmable processor, may receive data and instructions from a storage system, at least one input device and at least one output device, and may transmit the data and the instructions to the storage system, the at least one input device and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including machine readable medium that receives machine instructions as machine readable signals. The term “machine readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components, or the front-end component. Components of the system may be connected to each other through digital data communication in any form or medium (such as, a communication network). Examples of the communication network include a local area network (LAN), a wide area networks (WAN), and the Internet.

The computer system may include a client and a server. The client and the server are generally remote from each other and usually interact via the communication network. A relationship between the client and the server is generated by computer programs operated on a corresponding computer and having a client-server relationship with each other.

It is understandable, steps may be reordered, added or deleted by utilizing flows in the various forms illustrated above. For example, the steps described in the disclosure may be executed in parallel, sequentially or in different orders, so long as desired results of the technical solution disclosed by the disclosure may be achieved without limitation herein.

The above detailed implementations do not limit the protection scope of the disclosure. It should be understood by the skilled in the art that various modifications, combinations, subcombinations and substitutions may be made based on design requirements and other factors. Any modification, equivalent substitution and improvement made within the spirit and the principle of the disclosure shall be included in the protection scope of disclosure.

1. A method for detecting facial key points, comprising:
obtaining a face image to be detected, and extracting key point detection information of the face image to be detected;
obtaining key point template information of the template face image;
determining a facial key point mapping relationship between the face image to be detected and the template face image in combination with the key point detection information and the key point template information; and
filtering the key point detection information according to the facial key point mapping relationship and the key point template information to generate target key point information of the face image to be detected, wherein target facial key points in the target key point information are facial key points of an un-block area in the face image to be detected.

2. The method of claim 1, wherein determining the facial key point mapping relationship between the face image to be detected and the template face image in combination with the key point detection information and the key point template information comprises:
constructing a probability density function for the facial key point mapping relationship according to the key point template information and the key point detection information, wherein the probability density function is determined from distribution information of the facial key point mapping relationship of a blocked area in the face image to be detected and distribution information of the facial key point mapping relationship of the un-blocked area in the face image to be detected;
constructing an objective function and an expectation function for the facial key point mapping relationship according to the probability density function;
performing maximum likelihood estimation on the expectation function, re-determining the probability density function and the objective function according to the estimation result, re-determining the expectation function, and performing the maximum likelihood estimation until the objective function meets the preset convergence condition; and
determining the facial key point mapping relationship according to the probability density function determined when the preset convergence condition is satisfied.

3. The method of claim 1, wherein filtering the key point detection information according to the facial key point mapping relationship and the key point template information to generate the target key point information of the face image to be detected comprises:
for each facial key point in the key point detection information, determining whether the facial key point is a target facial key point according to the facial key point mapping relationship, template position information of the facial key point in the key point template information, and detection position information of the facial key point in the key point detection information; and
generating the target key point information of the face image to be detected according to the detection position information of the target face key points in the key point detection information.

4. The method of claim 3, wherein for each facial key point in the key point detection information, determining whether the facial key point is a target facial key point according to the facial key point mapping relationship, template position information of the facial key point in the key point template information, and detection position information of the facial key point in the key point detection information comprises:
for each facial key point in the key point detection information, determining evaluated position information of the facial key point according to the template position information of the facial key point and the facial key point mapping relationship; and
determining whether the facial key point is a target facial key point according to the evaluated position information and the detection position information of the facial key point.

5. The method of claim 4, wherein determining whether the facial key point is a target facial key point according to the evaluated position information and the detection position information of the facial key point comprises:
determining a distance between the evaluated position information and the detection position information of the facial key point;
in response to determining that the distance is less than or equal to a preset distance threshold, determining that the facial key point is a target facial key point; and
in response to determining that the distance is greater than the preset distance threshold, determining that the facial key point is a non-target facial key point.

6. The method of claim 1 further comprising:
performing face recognition on the face image to be detected based on the target key point information of the face image to be detected to obtain a recognition result.

7. The method of claim 2, wherein distribution information of the facial key point mapping relationship of the blocked area in the face image to be detected is uniform distribution information; and distribution information of the facial key point mapping relationship of the un-block area in the face image to be detected is Gaussian Mixture Distribution information.

8. The method of claim 7, wherein the calculation formula of the probability density function is:
$$p \left(x\right) = ω \frac{1}{N} + \left(1 - ω\right) {\sum }_{n = 1}^{N} p \left(x \vert n\right)$$
where, ^{x} represents the key point detection information of the face image to be detected, ω represents the proportion of the blocked area in the face image to be detected,
$$\frac{1}{N}$$
represents the uniform distribution information, and p(x|n) represents Gaussian distribution information.

9-16. (canceled)

17. An electronic device, comprising:
at least one processor; and
a memory, communicatively coupled with the at least one processor;
wherein the memory is configured to store instructions executable by the at least one processor, the instructions are executed by the at least one processor to cause the at least one processor to;
obtain a face image to be detected, and extract key point detection information of the face image to be detected;
obtain key point template information of the template face image;
determine a facial key point mapping relationship between the face image to be detected and the template face image in combination with the key point detection information and the key point template information; and
filter the key point detection information according to the facial key point mapping relationship and the key point template information to generate target key point information of the face image to be detected, wherein target facial key points in the target key point information are facial key points of an un-block area in the face image to be detected.

18. A non-transitory computer-readable storage medium, having computer instructions stored thereon, wherein the computer instructions are configured to cause a computer to execute a method for detecting facial key points the method comprising:
obtaining a face image to be detected, and extracting key point detection information of the face image to be detected;
obtaining key point template information of the template face image;
determining a facial key point mapping relationship between the face image to be detected and the template face image in combination with the key point detection information and the key point template information; and
filtering the key point detection information according to the facial key point mapping relationship and the key point template information to generate target key point information of the face image to be detected, wherein target facial key points in the target key point information are facial key points of an un-block area in the face image to be detected.

19. The electronic device of claim 18, wherein the at least processor is configured to:
construct a probability density function for the facial key point mapping relationship according to the key point template information and the key point detection information, wherein the probability density function is determined from distribution information of the facial key point mapping relationship of a blocked area in the face image to be detected and distribution information of the facial key point mapping relationship of the un-blocked area in the face image to be detected;
construct an objective function and an expectation function for the facial key point mapping relationship according to the probability density function;
perform maximum likelihood estimation on the expectation function, re-determine the probability density function and the objective function according to the estimation result, re-determine the expectation function, and perform the maximum likelihood estimation until the objective function meets the preset convergence condition; and
determine the facial key point mapping relationship according to the probability density function determined when the preset convergence condition is satisfied.

20. The electronic device of claim 17, wherein the at least processor is configured to:
for each facial key point in the key point detection information, determine whether the facial key point is a target facial key point according to the facial key point mapping relationship, template position information of the facial key point in the key point template information, and detection position information of the facial key point in the key point detection information; and
generate the target key point information of the face image to be detected according to the detection position information of the target face key points in the key point detection information.

21. The electronic device of claim 20, wherein the at least processor is configured to:
for each facial key point in the key point detection information, determine evaluated position information of the facial key point according to the template position information of the facial key point and the facial key point mapping relationship; and
determine whether the facial key point is a target facial key point according to the evaluated position information and the detection position information of the facial key point.

22. The electronic device of claim 21, wherein the at least processor is configured to:
determine a distance between the evaluated position information and the detection position information of the facial key point;
in response to determining that the distance is less than or equal to a preset distance threshold, determine that the facial key point is a target facial key point; and
in response to determining that the distance is greater than the preset distance threshold, determine that the facial key point is a non-target facial key point.

23. The electronic device of claim 17, wherein the at least processor is further configured to:
perform face recognition on the face image to be detected based on the target key point information of the face image to be detected to obtain a recognition result.

23. The electronic device of claim 19, wherein distribution information of the facial key point mapping relationship of the blocked area in the face image to be detected is uniform distribution information; and distribution information of the facial key point mapping relationship of the un-block area in the face image to be detected is Gaussian Mixture Distribution information.

24. The electronic device of claim 23, wherein the calculation formula of the probability density function is:
$$p \left(x\right) = ω \frac{1}{N} + \left(1 - ω\right) {\sum }_{n = 1}^{N} p \left(x \vert n\right)$$
where, x represents the key point detection information of the face image to be detected, ω represents the proportion of the blocked area in the face image to be detected,
$$\frac{1}{N}$$
represents the uniform distribution information, and p(x|n) represents Gaussian distribution information.

25. The non-transitory computer-readable storage medium of claim 18, wherein determining the facial key point mapping relationship between the face image to be detected and the template face image in combination with the key point detection information and the key point template information comprises:
constructing a probability density function for the facial key point mapping relationship according to the key point template information and the key point detection information, wherein the probability density function is determined from distribution information of the facial key point mapping relationship of a blocked area in the face image to be detected and distribution information of the facial key point mapping relationship of the un-blocked area in the face image to be detected;
constructing an objective function and an expectation function for the facial key point mapping relationship according to the probability density function;
performing maximum likelihood estimation on the expectation function, re-determining the probability density function and the objective function according to the estimation result, re-determining the expectation function, and performing the maximum likelihood estimation until the objective function meets the preset convergence condition; and
determining the facial key point mapping relationship according to the probability density function determined when the preset convergence condition is satisfied.

26. The non-transitory computer-readable storage medium of claim 18, wherein filtering the key point detection information according to the facial key point mapping relationship and the key point template information to generate the target key point information of the face image to be detected comprises:
for each facial key point in the key point detection information, determining whether the facial key point is a target facial key point according to the facial key point mapping relationship, template position information of the facial key point in the key point template information, and detection position information of the facial key point in the key point detection information; and
generating the target key point information of the face image to be detected according to the detection position information of the target face key points in the key point detection information.

27. The non-transitory computer-readable storage medium of claim 26, wherein for each facial key point in the key point detection information, determining whether the facial key point is a target facial key point according to the facial key point mapping relationship, template position information of the facial key point in the key point template information, and detection position information of the facial key point in the key point detection information comprises:
for each facial key point in the key point detection information, determining evaluated position information of the facial key point according to the template position information of the facial key point and the facial key point mapping relationship; and
determining whether the facial key point is a target facial key point according to the evaluated position information and the detection position information of the facial key point.
